(19) United States
(12) Patent Application Publication
(10) Pub. No.: US 2017/0330473 A1
(43) Pub. Date: Nov. 16, 2017

(54) IOT ENHANCED EDUCATIONAL SYSTEM

(71) Applicant: National Taiwan Normal University, Taipei City (TW)

(72) Inventors: Jon-Chao HONG, Taipei City (TW); Kai-Hsiang YANG, Taipei City (TW); Ming-Yueh HWANG, Taipei City (TW); Kai-Hsin TAI, Taipei City (TW); Chi-Ruei TSAI, Taipei City (TW)

(73) Assignee: National Taiwan Normal University, Taipei City (TW)

(21) Appl. No.: 15/390,929

(22) Filed: Dec. 27, 2016

(30) Foreign Application Priority Data
May 13, 2016 (TW) 105114835

(51) Int. Cl. G09B 7/02; G09B 19/06; G09B 19/02; G09B 5/02; A63F 9/24; G09B 19/22; A63F 3/02

(52) U.S. Cl. CPC G09B 7/02; G09B 19/22; G09B 19/06; A63F 3/02; G09B 5/02; A63F 9/24; G09B 19/02

(57) ABSTRACT

An IoT enhanced educational system is to be operated by a user, and includes a learning aid unit, a positioning unit and a processing unit. The learning aid unit includes a plurality of objects that are configured to be moved by the user. The positioning unit is configured to determine a position of each of the objects and to generate position data associated with the positions of the objects. The processing unit is electrically connected to the positioning unit for receiving therefrom the position data, and is configured to generate, according to the positions of the objects contained in the position data, an assessment associated with the user.

### CROSS-REFERENCE TO RELATED APPLICATION

This application claims priority of Taiwanese Patent Application No. 105114835, filed on May 13, 2016,

### FIELD

The disclosure relates to an educational gaming system, and more particularly to an IoT enhanced educational system including a physical learning aid and a processing unit.

### BACKGROUND

A conventional educational instrument (such as a jigsaw puzzle, building blocks, and so on) is manipulatable by a user through moving or rotating the same. Operating the conventional educational instrument under a predetermined set of rules is generally helpful in the development of learning ability and intelligence.

An operation result of the conventional educational instrument may be utilized for assessment of a problem solving ability of the user. However, the conventional educational instrument itself cannot generate any such assessment.

### SUMMARY

Therefore, an object of the disclosure is to provide an IoT enhanced educational system that can alleviate at least one of the drawbacks of the prior art.

According to one aspect of the disclosure, the IoT enhanced educational system is to be operated by a user, and includes a learning aid unit, a positioning unit and a processing unit.

The learning aid unit includes a plurality of objects that are configured to be moved by the user. The positioning unit is configured to determine a position of each of the objects and to generate position data associated with the positions of the objects. The processing unit is configured to receive the position data from the positioning unit, and is configured to generate, according to the positions of the objects contained in the position data, an assessment associated with the user.

According to another aspect of the disclosure, the IoT enhanced educational system is to be operated by a user, and includes a learning aid unit, a positioning unit, an orientation detecting unit and a processing unit.

The learning aid unit includes a plurality of objects that are configured to be moved by the user. The positioning unit is configured to determine a position of each of the objects and to generate position data associated with the positions of the objects. The orientation detecting unit is configured to determine an orientation of each of the objects and to generate orientation data associated with the orientations of the objects. The processing unit is configured to receive the position data and the orientation data respectively from the positioning unit and the orientation detecting unit, and to generate, according to at least one of the positions of the objects contained in the position data or the orientations of the objects contained in the orientation data, an assessment associated with the user.

### BRIEF DESCRIPTION OF THE DRAWINGS

Other features and advantages of the disclosure will become apparent in the following detailed description of the embodiments with reference to the accompanying drawings, of which:

FIG. 1 is a block diagram illustrating a first embodiment of an IoT enhanced educational system according to the disclosure;

FIG. 2 is a schematic view illustrating embodiments of a learning aid unit and a positioning unit of the IoT enhanced educational system;

FIG. 3 is a schematic view illustrating one embodiment of an objective displayed by a display unit of the IoT enhanced educational system;

FIG. 4 is a schematic view illustrating an example regarding how an object of the learning aid unit of the education gaming system is moved;

FIG. 5 is a schematic view illustrating another example regarding how the object of the learning aid unit of the IoT enhanced educational system is moved in a different way;

FIG. 6 is a schematic view illustrating one embodiment of a hint displayed by the display unit of the IoT enhanced educational system;

FIG. 7 is a schematic view illustrating a learning aid unit and a positioning unit of a second embodiment of the IoT enhanced educational system;

FIG. 8 is a schematic view illustrating one embodiment of words on objects of the learning aid unit of the IoT enhanced educational system that are arranged to form a grammatically correct sentence;

FIG. 9 is a block diagram illustrating a third embodiment of the IoT enhanced educational system according to the disclosure;

FIG. 10 is a schematic view illustrating embodiments of a learning aid unit, a positioning unit and an orientation detecting unit of the IoT enhanced educational system;

FIG. 11 is a schematic view illustrating one embodiment of mathematical notations on objects of the learning aid unit of the IoT enhanced educational system that are arranged to form a correct mathematical expression;

FIG. 12 is a schematic view illustrating one embodiment of a learning aid unit, a positioning unit and an orientation detecting unit of the IoT enhanced educational system; and

FIG. 13 is a schematic view illustrating one embodiment of a recommendation displayed by a display unit of the IoT enhanced educational system.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

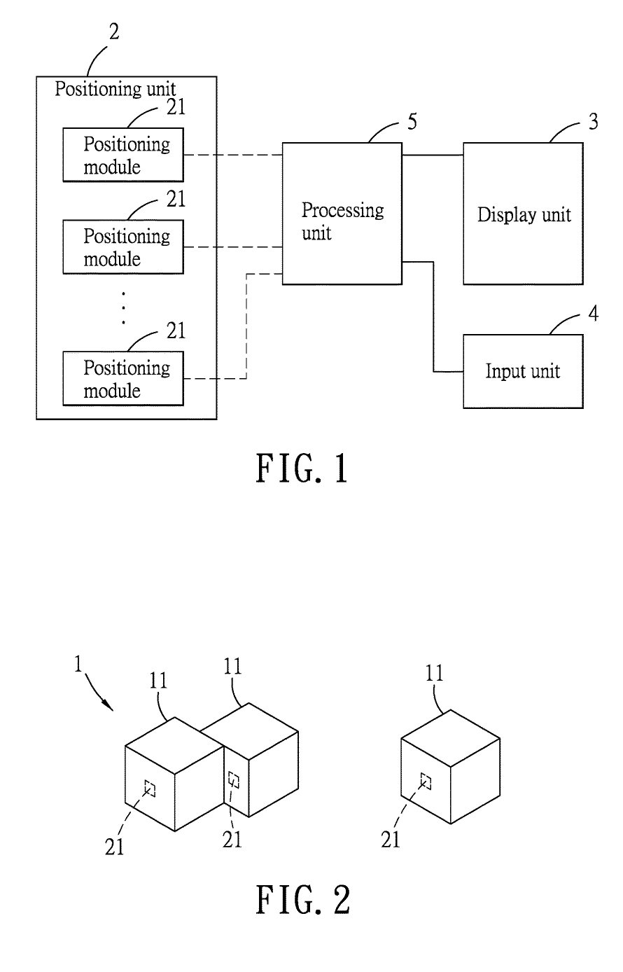

Referring to FIGS. 1 and 2, a first embodiment of an Internet of Things (IoT) enhanced educational system to be operated by a user according to the disclosure is illustrated. The IoT is a technique internetworking computing devices and different kinds of items that are provided with unique identifiers and network connectivity for collecting and exchanging data. The DDT enhanced educational system includes a learning aid unit 1, a positioning unit 2, a display unit 3, an input unit 4 and a processing unit 5.

The learning aid unit 1 includes a plurality of objects 11 that are configured to be moved by the user. The user is prompted to meet an objective by moving the objects 11. In this embodiment, each one of the objects 11 is exemplified as a piece of building block having a cubic shape.

The positioning unit 2 is configured to determine a position of each of the objects 11 and to generate position data associated with the positions of the respective objects 11. In this embodiment, the positioning unit 2 includes a plurality of positioning modules 21 respectively disposed on the objects 11. Each of the positioning modules 21 is configured to determine the position of the respective one of the objects 11, to generate a respective part of the position data associated with the position of the respective one of the objects 11, and to transmit the respective part of the position data wirelessly to the processing unit 5.

The display unit 3 is electrically connected to the processing unit 5, and is configured to be controlled by the processing unit 5 to display the objective.

The input unit 4 is electrically connected to the processing unit 5 and is to be operated by the user for input.

The processing unit 5 is capable of establishing electrical communication with the positioning unit 2 for receiving therefrom the position data, and is configured to generate, according to the positions of the respective objects 11 contained in the position data, an assessment associated with the user. Specifically speaking, the processing unit 5 is configured to determine a displacement of each of the objects 11 according to a current one of the position data and a previous one of the position data, and to generate, according to the displacements of the respective objects 11, the assessment which is associated with a problem solving capability of the user.

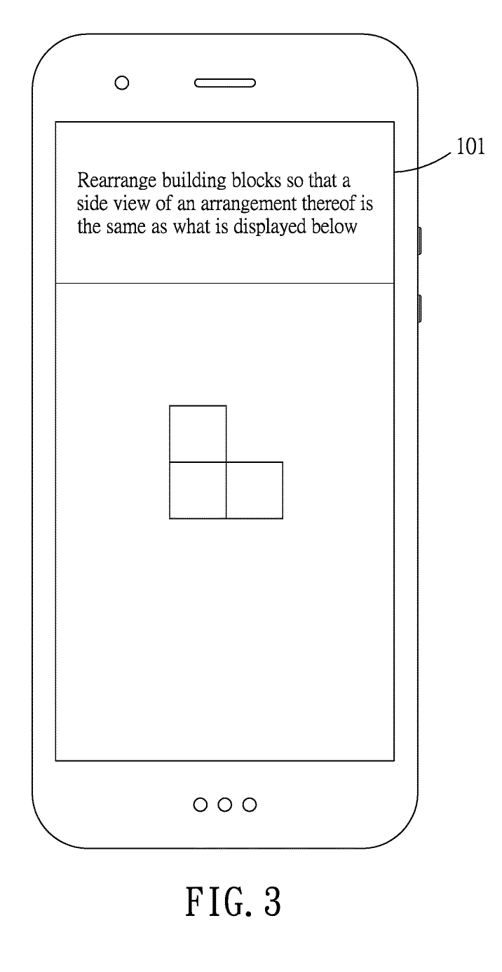

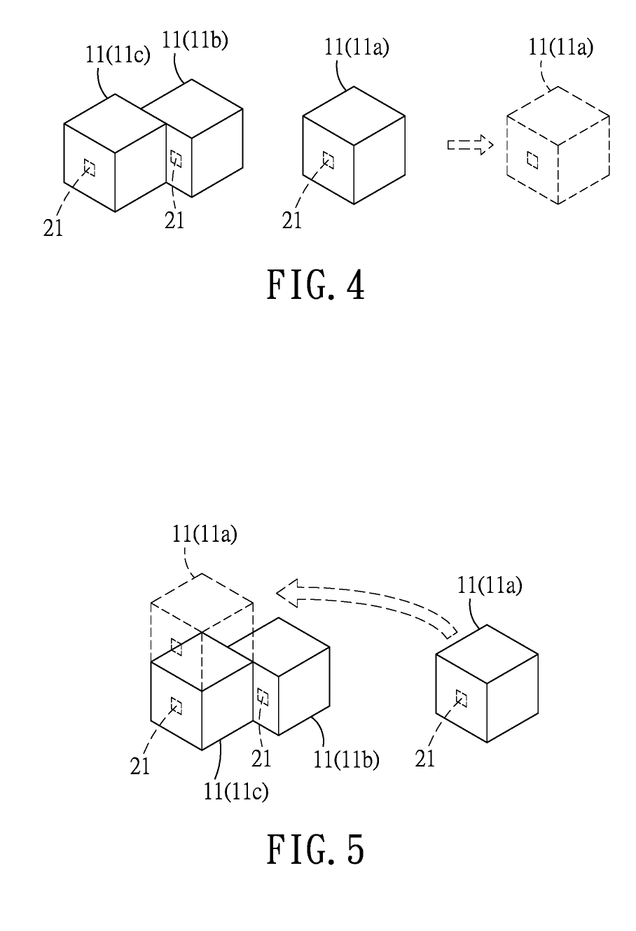

In this embodiment, the display unit 3 is controlled by the processing unit 5 to display an objective 101 as shown in FIG. 3 when the IoT enhanced educational system is operated by the user. In this embodiment, the objective 101 prompts the user to rearrange the objects 11 so that a side view of an arrangement of the objects 11 is the same as a request that is displayed in a lower portion of the display unit 3 (i.e., an L-shaped arrangement of building blocks). Thereafter, the user may try to meet the objective 101 by moving the objects 11 around. According to the displacements of the respective objects 11, the processing unit 5 generates the assessment which is associated with the problem solving capability of the user. For example, as shown in FIG. 4, the user may move the object (11a) away from the objects (11b and 11c), or as shown in FIG. 5, the user may stack the object (11a) on the object (11c). Since the arrangement of the objects 11 in FIG. 5 is identical to the L-shaped arrangement of building blocks for meeting the objective 101, and since that in FIG. 4 is different from the L-shaped arrangement of building blocks shown in FIG. 3, a result of the assessment generated by the processing unit 5 according to the displacement shown in FIG. 5 is superior to that generated according to the displacement shown in FIG. 4.

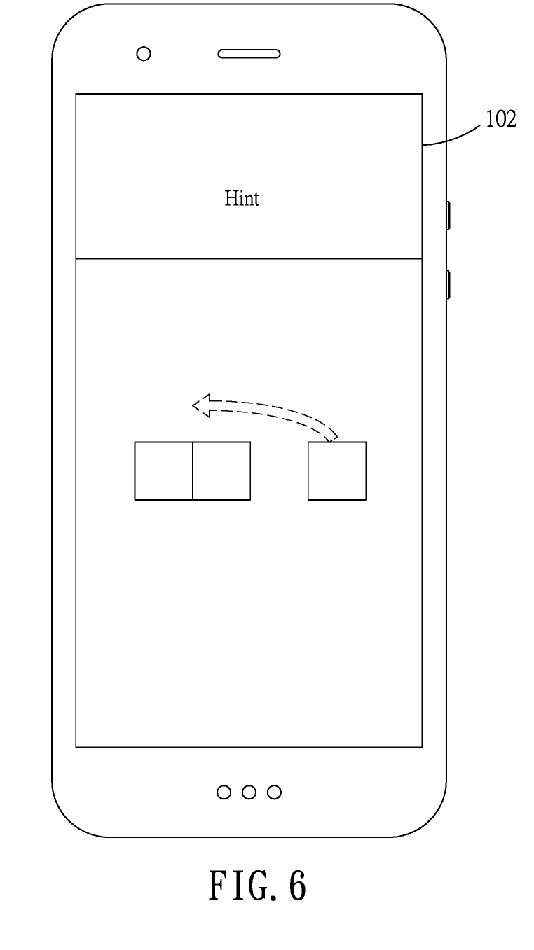

Moreover, during the process of trying to meet the objective 101 by the user, the processing unit 5 is configured to generate, according to the positions of the respective objects 11, a hint 102 as shown in FIG. 6 for instructing how to move at least one of the objects 11 so that arrangement of the objects 11 satisfies the request for meeting the objective 101, and to display the hint 102 by the display unit 3. In this embodiment, the input unit 4 is configured to be operated by the user to generate a hint request to be transmitted to the processing unit 5. After receiving the hint request, the processing unit 5 controls the display unit 3 to display the hint 102.

After the user finishes the moves, in some embodiments, the input unit 4 is configured to be operated by the user to generate a submission confirmation to be transmitted to the processing unit 5. In response to receiving the submission confirmation from the input unit 4, the processing unit 5 determines according to the position data acquired after the receipt of the submission confirmation whether the arrangement of the objects 11 satisfies the request. In other embodiments, the processing unit 5 determines whether the arrangement of the objects 11 satisfies the request when it is determined by the processing unit 5 that one of the objects 11 has been moved according to the current one of the position data and the previous one of the position data. In other words, in such embodiment, the processing unit 5 makes a determination each time one of the objects 11 is moved.

When it is determined by the processing unit 5 according to the position data that the arrangement of the objects 11 satisfies the request, the processing unit 5 controls the display unit 3 to display a success indication indicating that the user has successfully met the objective 101. When it is determined by the processing unit 5 according to the position data that the arrangement of the objects 11 does not satisfy the request, the processing unit 5 controls the display unit 3 to display a failure indication indicating that the user has failed to meet the objective 101.

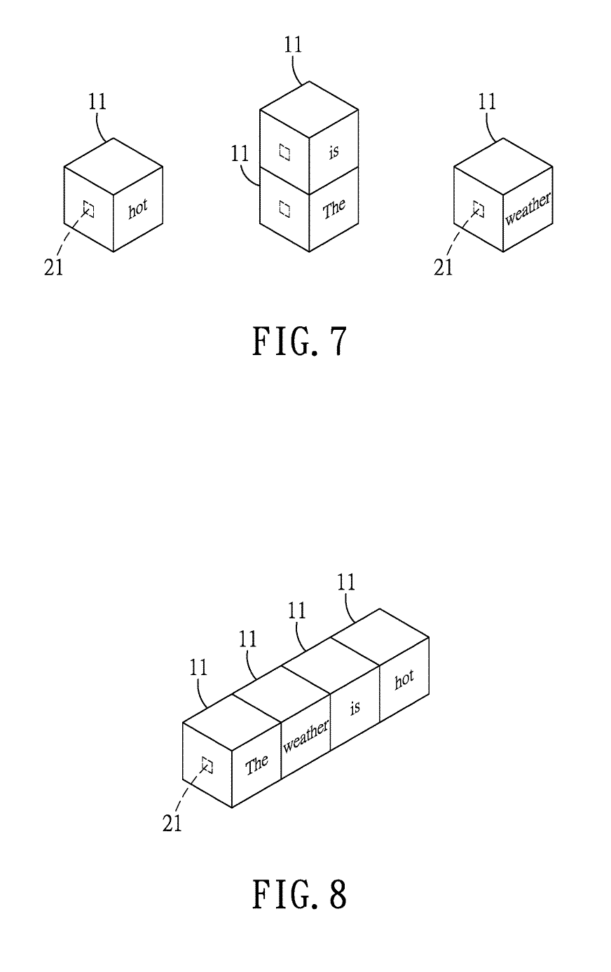

Referring to FIGS. 7 and 8, a second embodiment of the IoT enhanced educational system similar to the first embodiment is illustrated. In this embodiment, each of the objects 11 is a piece of building block having a cubic shape as well, but is different in that each of the objects 11 is provided with a presentation of a word notation, such as “is”, “weather”, “hot” and “The”. When the words presented on the respective objects 11 are arranged to form a grammatically correct sentence, such as “The weather is hot” shown in FIG. 8, the processing unit 5 determines according to the position data that the arrangement of the objects 11 satisfy the request.

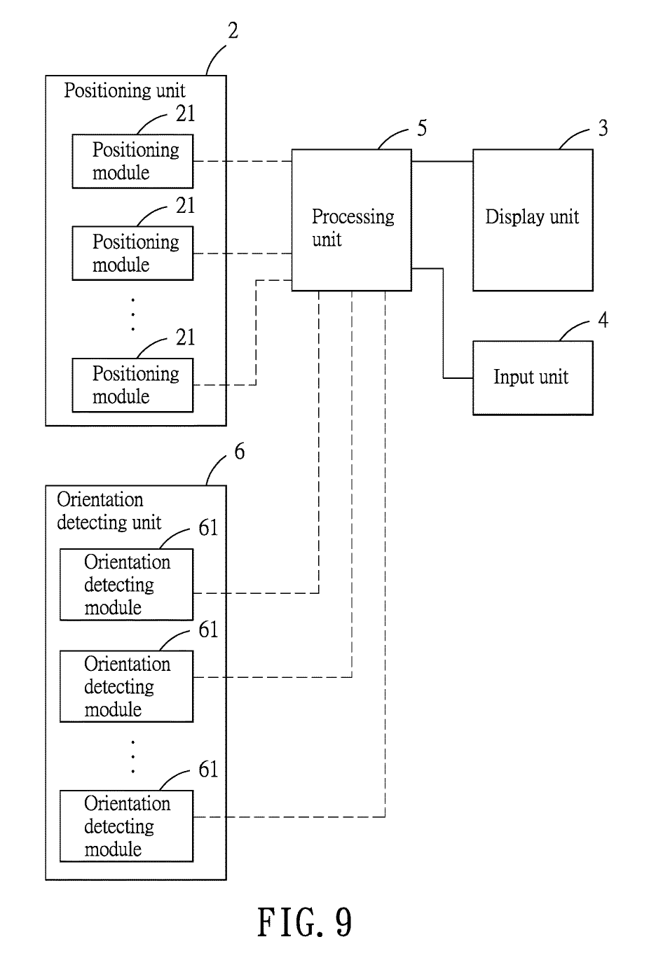

Referring to FIGS. 9 to 11, a third embodiment of the IoT enhanced educational system similar to the first embodiment is illustrated. The difference is described in the following.

In this embodiment, the IoT enhanced educational system further includes an orientation detecting unit 6 configured to determine an orientation of each of the objects 11 and to generate orientation data associated with the orientations of the respective objects 11. The orientation detecting unit 6 of this embodiment includes a plurality of orientation detecting modules 61 respectively disposed on the objects 11. Each of the orientation detecting modules 61 is configured to determine the orientation of the respective one of the objects 11, to generate a respective part of the orientation data associated with the orientation of the respective one of the objects 11, and to transmit wirelessly the respective part of the orientation data to the processing unit 5.

The processing unit 5 is capable of establishing electrical communication with the orientation detecting unit 6 for receiving therefrom the orientation data, to determine a rotation of each of the objects 11 according to a current one of the orientation data and a previous one of the orientation data, and to generate, according to at least one of the displacements or the rotations of the corresponding objects 11, the assessment associated with the user.

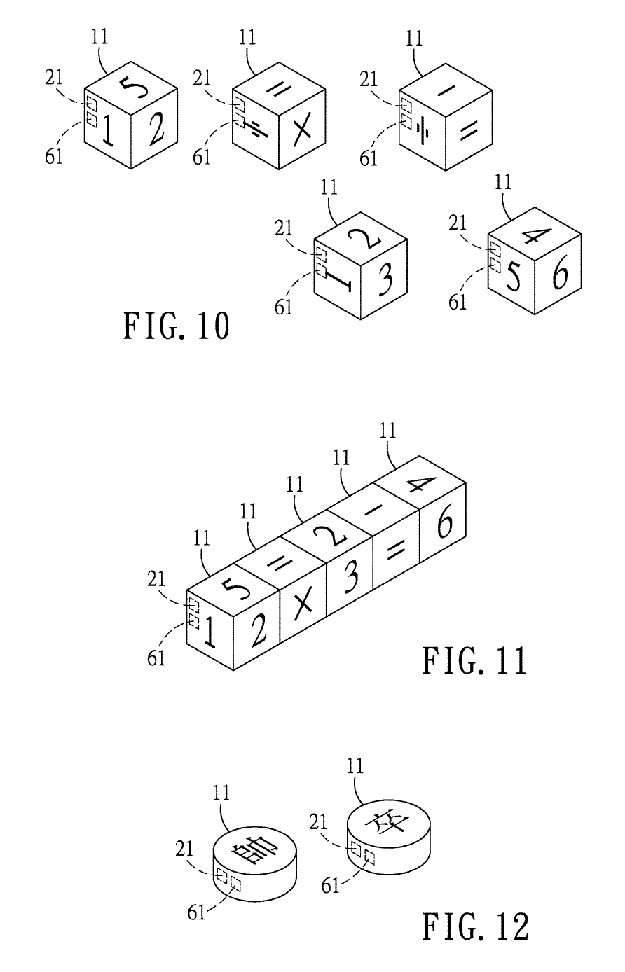

Referring to FIG. 10, in this embodiment, each of the objects 11 is a piece of building block having a cubic shape as well. Each surface of each one of the objects 11 is provided with a presentation of a mathematical notation, such as “−”, “×”, “=”, “3” and “5”, and the user is prompted to meet the objective by moving or turning the objects 11 such that an arrangement and orientations of the objects 11 satisfy a request, such as “present a correct mathematical expression using the building blocks”.

The processing unit 5 is configured to determine whether the arrangement and the orientations of the objects 11 satisfy the request when it is determined by the processing unit 5 that one of the objects 11 has been moved according to the current one of the position data and the previous one of the position data, or when it is determined by the processing unit 5 that one of the objects 11 has been turned according to the current one of the orientation data and the previous one of the orientation data.

Referring to FIG. 11, when the mathematical notations presented on the respective objects 11 are arranged to form a correct mathematical expression and to face the same direction, for example, “2×3=6”, the processing unit 5 determines according to the position data and the orientation data that the arrangement and the orientations of the objects 11 satisfy the request, and controls the display unit 3 to display the success indication indicating that the user has successfully met the objective. In contrast, when it is determined by the processing unit 5 according to at least one of the position data or the orientation data that at least one of the placement or the orientations of the objects 11 do not satisfy the request, the processing unit 5 controls the display unit 3 to display the failure indication indicating that the user has failed to meet the objective.

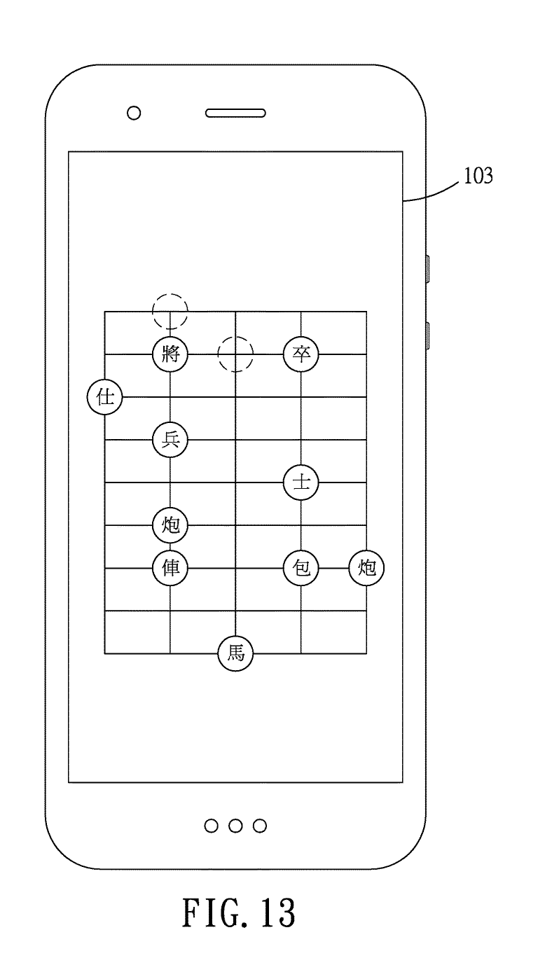

Referring to FIGS. 12 and 13, a fourth embodiment of the IoT enhanced educational system similar to the third embodiment is illustrated. The difference is described in the following.

In this embodiment, each of the objects 11 is exemplified as a chess piece. A surface of each one of the objects 11 is provided with a presentation of a traditional Chinese character, such as “ [symbol] (General on the black side)”, “ [symbol] (General on the red side)”, “ [symbol] (Advisor on the red side)”, “ [symbol] (Soldier on the black side)”, “ [symbol] (Soldier on the red side)” and “ [symbol] (Horse on the black side)”. When the user is playing a board game using these chess pieces, the processing unit 5 generates an illegitimate notification for notifying that at least one of movement or rotation of at least one of the objects 11 does not comply with a predetermined rule (or a predetermined set of rules) when it is determined by the processing unit 5, according to the current one of the position data and the previous one of the position data, that the displacement of at least one of the objects 11 does not comply with the predetermined rule (or the predetermined set of rules), or when it is determined by the processing unit 5, according to the current one of the orientation data and the previous one of the orientation data, that the rotation of at least one of the objects 11 does not comply with the predetermined rule (or the predetermined set of rules) Then, the processing unit 5 controls the display unit 3 to display the illegitimate notification. For example, the chess piece depicting “ [symbol] (Horse on the black side) is only allowed to be operated to move and capture one point orthogonally and then one point diagonally away from its former position. When the chess piece depicting “ [symbol] (Horse on the black side)” is operated to move not in the above-mentioned way, i.e., the user made an illegal move, the processing unit 5 controls the display unit 3 to display the illegitimate notification.

Additionally, the processing unit 5 is configured to generate, according to the position data, a recommendation 103 for advising how to move at least one of the chess pieces, and to control the display unit 3 to display the recommendation 103. For example, in FIG. 13, the recommendation 103 advises the user to move the chess piece depicting “ [symbol] (General on the black side)” to move one point upward or one point rightward so as to avoid being captured by the chess piece depicting “ [symbol] (Advisor on the red side)” and “ [symbol] (Soldier on the red side)”. In this embodiment, when the user inputs by the input unit 4 a command asking for the recommendation 103, the processing unit 5 receives the command from the input unit 4 and controls the display unit 3 to display the recommendation 103.

It is worth to note that the learning aid unit 1 is exemplified by the building blocks and the chess pieces. However, the embodiment of the learning aid unit 1 is not limited thereto, and can be implemented by any tool or toy that is educational and recreational.

Additionally, the positioning unit 2 may be, but is not limited to be, implemented with Wi-Fi Positioning System (WPS) or Global Positioning System (GPS) technologies so as to obtain the position data of the objects 11. The orientation detecting modules 61 of the orientation detecting unit 6 may be implemented by gyroscopes or accelerometers so as to obtain the orientation data of the objects 11. The part of position data and the part of orientation data of each of the objects 11 generated respectively by the positioning module 21 and the orientation detecting module 61 disposed thereon may be transmitted by a micro processor (not shown) disposed on the same object 11 via a computer network to a server unit. The server unit and a computing device, such as a smart phone or a computer, may serve as the processing unit 5 to perform the aforementioned analysis on the position data and/or the orientation data, and to output a result regarding the analysis on the position data and/or the orientation data. The input unit 4 may be a touchsreen of the smartphone, or a keyboard and a mouse of the computer. The display unit 3 may be a screen of the smartphone or a monitor of the computer. In some other embodiments, the positioning unit 2 and the orientation detecting unit 6 may be implemented with short-range wireless communication technology, such as Bluetooth technology, to directly communicate with the smartphone without the computer network being an intermediate transmission medium. A processor of the smartphone serves as the processing unit 5 which performs the analysis on the position data and/or the orientation data, and outputs the result regarding the analysis on the position data and/or the orientation data.

In summary, the IoT enhanced educational system of this disclosure obtains the position data of the objects 11 by the positioning unit 2, obtains the orientation data of the objects 11 by the orientation detecting unit 6, generates the assessment associated with the problem solving capability of the user according to the displacements and/or the rotations of the respective objects 11.

In the description above, for the purposes of explanation, numerous specific details have been set forth in order to provide a thorough understanding of the embodiments. It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. An Internet of things (IOT) enhanced educational system to be operated by a user, said IoT enhanced educational system comprising:
a learning aid unit including a plurality of objects that are configured to be moved by the user;
a positioning unit configured to determine a position of each of said objects and to generate position data associated with the positions of said objects; and
a processing unit configured to receive the position data from said positioning unit, and configured to generate, according to the positions of said objects contained in the position data, an assessment associated with the user.

2. The IoT enhanced educational system as claimed in claim 1, the user being prompted to meet an objective by moving the objects, wherein:
said processing unit is further configured to determine a displacement of each of said objects according to a current one of the position data and a previous one of the position data, and to generate, according to the displacements of said objects, the assessment which is associated with a problem solving capability of the user.

3. The IoT enhanced educational system as claimed in claim 2, further comprising:
a display unit electrically connected to said processing unit;
wherein said processing unit is further configured to generate, according to the positions of said objects, a hint for instructing how to move at least one of said objects so that arrangement of said objects satisfies a request for meeting the objective, and to display the hint by said display unit.

4. The IoT enhanced educational system as claimed in claim 3, wherein said processing unit is further configured to:
control said display unit to display a success indication indicating that the user has successfully met the objective when it is determined by said processing unit according to the position data that the arrangement of said objects satisfies the request; and
control said display unit to display a failure indication indicating that the user has failed to meet the objective when it is determined by said processing unit according to the position data that the arrangement of said objects does not satisfy the request.

5. The IoT enhanced educational system as claimed in claim 4, wherein said processing unit determines whether the arrangement of said objects satisfies the request when it is determined by said processing unit that one of said objects has been moved according to the current one of the position data and the previous one of the position data.

6. The IoT enhanced educational system as claimed in claim 4, further comprising an input unit that is configured to be operated by the user to generate a submission confirmation to be transmitted to said processing unit, said processing unit being configured to receive the submission confirmation from said input unit and determining according to the position data whether the arrangement of said objects satisfies the request upon receiving the submission confirmation from said input unit.

7. The IoT enhanced educational system as claimed in claim 4, wherein:
each of said objects is provided with a presentation of one of a word and a mathematical notation; and
when the words presented on said objects are arranged to form a grammatically correct sentence, or when the mathematical notations presented on said objects are arranged to form a correct mathematical expression, said processing unit determines according to the position data that the arrangement of said objects satisfy the request.

8. The IoT enhanced educational system as claimed in claim 2, further comprising:
a display unit electrically connected to said processing unit;
wherein said processing unit is configured to generate an illegitimate notification for notifying that movement of at least one of said objects does not comply with a predetermined rule when it is determined by said processing unit, according to the current one of the position data and the previous one of the position data, that the displacement of at least one of said objects does not comply with the predetermined rule, and to control said display unit to display the illegitimate notification.

9. The IoT enhanced educational system as claimed in claim 8, wherein:
each of said objects is a chess piece; and
said processing unit is configured to generate, according to the position data, a recommendation for advising how to move at least one of said chess pieces, and to control said display unit to display the recommendation.

10. The IoT enhanced educational system as claimed in claim 1, wherein said positioning unit includes a plurality of positioning modules respectively disposed on said objects, and each of said positioning modules is configured to determine the position of the respective one of said objects.

11. An IoT enhanced educational system to be operated by a user, said IoT enhanced educational system comprising:
a learning aid unit including a plurality of objects that are configured to be moved by the user;
a positioning unit configured to determine a position of each of said objects and to generate position data associated with the positions of said objects;
an orientation detecting unit configured to determine an orientation of each of said objects and to generate orientation data associated with the orientations of said objects; and
a processing unit configured to receive the position data and the orientation data respectively from said positioning unit and said orientation detecting unit, and to generate, according to at least one of the positions of said objects contained in the position data or the orientations of said objects contained in the orientation data, an assessment associated with the user.

12. The IoT enhanced educational system as claimed in claim 11, the user being prompted to meet an objective by moving or turning the objects, wherein:
said processing unit is further configured to determine a displacement of each of said objects according to a current one of the position data and a previous one of the position data, to determine a rotation of each of said objects according to a current one of the orientation data and a previous one of the orientation data, and to generate, according to at least one of the displacements or the rotations of said corresponding objects, the assessment which is associated with a problem solving capability of the user.

13. The IoT enhanced educational system as claimed in claim 12, further comprising:
a display unit electrically connected to said processing unit;
wherein said processing unit is further configured to generate, according to the positions and the rotations of said corresponding objects, a hint for instructing how to move or to turn at least one of said objects so that arrangement and the orientations of said objects satisfy a request for meeting the objective, and to display the hint by said display unit.

14. The IoT enhanced educational system as claimed in claim 13, wherein said processing unit is further configured to:
control said display unit to display a success indication indicating that the user has successfully met the objective when it is determined by said processing unit according to the position data and the orientation data that the arrangement and the orientations of said objects satisfy the request; and
control said display unit to display a failure indication indicating that the user has failed to meet the objective when it is determined by said processing unit according to at least one of the position data or the orientation data that at least one of the arrangement or the orientations of said objects do not satisfy the request.

15. The IoT enhanced educational system as claimed in claim 14, wherein said processing unit determines whether the arrangement and the orientations of said objects satisfy the request when it is determined by said processing unit that one of said objects has been moved according to the current one of the position data and the previous one of the position data, or when it is determined by said processing unit that one of said objects has been turned according to the current one of the orientation data and the previous one of the orientation data.

16. The IoT enhanced educational system as claimed in claim 14, further comprising an input unit that is configured to be operated by the user to generate a submission confirmation to be transmitted to said processing unit, said processing unit being configured to receive the submission confirmation from said input unit, and determining according to the position data and the orientation data whether the arrangement and orientations of said objects satisfy the request upon receiving the submission confirmation from said input unit.

17. The IoT enhanced educational system as claimed in claim 14, wherein:
each of said objects is provided with a presentation of one of a word and a mathematical notation; and
when the words presented on said objects are arranged to form a grammatically correct sentence and to face the same direction, or when the mathematical notations presented on said objects are arranged to form a correct mathematical expression and to face the same direction, said processing unit determines according to the position data and the orientation data that the arrangement and the orientations of said objects satisfy the request.

18. The IoT enhanced educational system as claimed in claim 12, further comprising:
a display unit electrically connected to said processing unit;
wherein said processing unit is configured to generate an illegitimate notification for notifying that at least one of movement or the rotation of at least one of said objects does not comply with a predetermined rule when it is determined by said processing unit, according to the current one of the position data and the previous one of the position data, that the displacement of at least one of said objects does not comply with the predetermined rule, or when it is determined by said processing unit, according to the current one of the orientation data and the previous one of the orientation data, that the rotation of at least one of said objects does not comply with the predetermined rule, and to control said display unit to display the illegitimate notification.

19. The IoT enhanced educational system as claimed in claim 18, wherein:
each of said objects is a chess piece; and
said processing unit is configured to generate, according to at least one of the position data or the orientation data, a recommendation for advising how to move or to turn at least one of said chess pieces, and to control said display unit to display the recommendation.

20. The IoT enhanced educational system as claimed in claim 11, wherein:
said positioning unit includes a plurality of positioning modules respectively disposed on said objects, and each of said positioning modules is configured to determine the position of the respective one of said objects;
said orientation detecting unit includes a plurality of orientation detecting modules respectively disposed on said objects, and each of said orientation detecting modules is configured to determine the orientation of the respective one of said objects.
